(19) United States
(12) Patent Application Publication
(10) Pub. No.: US 2009/0296746 A1
(43) Pub. Date: Dec. 3, 2009

(54) FIBER LASER COIL FORM AND RELATED MANUFACTURING TECHNIQUES

(75) Inventors: Larry Christopher Heaton, Huntsville, AL (US); Jeff Williams, Huntsville, AL (US)

Correspondence Address: GREENBERG TRAURIG, LLP (DC/ORL), 2101 L Street, N.W., Suite 1000, Washington, DC, 20037, US

(73) Assignee: Morgan Research Corporation, Huntsville, AL (US)

(21) Appl. No.: 12/405,088

(22) Filed: Mar. 16, 2009

Related U.S. Application Data
(60) Provisional application No. 61/036,950, filed on Mar. 15, 2008.

(51) Int. Cl. H01S 3/30; B65H 75/04; B65H 75/18; B65H 54/00; B21F 3/04; B65H 81/00

(52) U.S. Cl. 372/6; 242/600; 242/610.5; 242/583; 242/430

(57) ABSTRACT

A fiber laser thermal coil form and related manufacturing techniques that are substantially suitable for automation. The fiber laser thermal coil form including a thermally conductive substrate to support a fiber placed thereon and to dissipate a heat of the fiber, and a fiber guide groove defined in a surface of the substrate to guide the fiber and dimensioned to partially enclose the fiber and to enhance a thermal contact of the fiber and the substrate.

### CROSS-REFERENCE TO RELATED APPLICATIONS

This application claims priority from U.S. Provisional Patent Application Ser. No. 61/036,950, filed on Mar. 15, 2008, the disclosure of which is hereby incorporated by reference in its entirety.

### COPYRIGHT NOTIFICATION

This application includes material which is subject to copyright protection. The copyright owner has no objection to the facsimile reproduction by anyone of the patent disclosure, as it appears in the Patent and Trademark Office files or records, but otherwise reserves all copyright rights whatsoever.

### BACKGROUND OF THE INVENTION

1. Field of the Invention

The present application relates to fiber lasers and fiber laser coils, and more particularly, to fiber laser coil forms, and methods and apparatuses to fabricate fiber lasers using the same.

2. Description of the Related Art

The ability of lasers to efficiently deliver coherent monochromatic light has made them popular in household, commercial, medical, military, and industrial applications. Lasers can be found in household CD/DVD players, laser rangefinders, and laser levels. Commercial applications include barcode readers and surveying equipment. In industry, laser interferometry is used to provide precise movement in various processes including photolithography and metrology. High power lasers may also be used for cutting, marking, and welding applications. When combined with a precision stage and a CNC (Computer Numerical Control) controller, high power lasers can be used to rapidly fabricate precision components.

Fiber lasers may utilize a doped optical fiber as an active gain medium. Fiber lasers are advantageous in that their output is generally already coupled to a fiber optic waveguide and can be precisely delivered to a target. By utilizing an optical fiber as the active gain medium, the fiber can be coiled, making the fiber lasers more compact than traditional solid state and gas lasers of the same output level. Fiber lasers have become especially popular in industrial settings because of their compact size, resistance to vibration, and relatively maintenance-free operation.

Conventional fiber lasers are fabricated by manually coiling an optical fiber around a cylindrical mandrel to reduce the footprint of the fiber laser. Because laser fibers may radiate heat during a lasing process, the amount of heat produced may affect heat-sensitive components of the fiber laser or may reduce an efficiency of the fiber laser. For example, because the fiber is manually wound around the mandrel, there is an increased chance that the fiber will cross over itself as it is wound. This leads to hot-spots at cross-over locations. These hot-spots may affect the dimensions of the laser and thus, affect a shift in the frequency of the output laser or otherwise impact its characteristics. In addition, the coiling of fiber around the mandrel may introduce mechanical stresses as the fibers are wound on top of each other. Conventional fiber laser assembly being labor intensive, the costs associated with manufacture are relatively high. Moreover, manual fabrication of the fiber laser inherently results in non-uniformity of performance and thermal characteristics caused by differences in coiling between manually coiled fibers.

Accordingly, there is a need for a coiled fiber laser and related manufacturing techniques that substantially obviates one or more of the disadvantages of conventional fiber lasers.

### SUMMARY OF THE INVENTION

The present invention provides a fiber laser coil form to allow for the uniform and automated fabrication of a fiber laser using the same.

The present invention also provides a fiber laser coil form with favorable thermal characteristics to effectively dissipate heat produced by the fiber laser coil.

The present invention also provides a winding head to place fiber on a fiber laser coil form.

The present invention also provides an apparatus to assemble fiber laser coils.

The present invention also provides a method of placing a fiber on a fiber laser coil form.

The present invention also provides a system for assembling fiber laser coils usable to fabricate fiber lasers. and related manufacturing techniques having favorable thermal characteristics thereby substantially minimizing stress-induced birefringence in the fiber laser due to mechanical perturbations and variations in temperature of the gain fiber in particular

The present invention also provides a fiber laser thermal coil form to minimize stress-induced birefringence in the fiber laser due to mechanical perturbations and variations in temperature of the fiber.

Additional features and advantages of the invention will be set forth in the description which follows, and in part will be apparent from this disclosure, or may be learned by practice of the invention. The objectives and other advantages of the invention will be realized and attained by the structure particularly pointed out in this written description, including any claims contained herein and the appended drawings.

The foregoing and/or other aspects and utilities of the present invention may be achieved by providing a fiber coil form, including a substrate to support a fiber placed thereon, and a fiber guide to guide the fiber into a coil, the fiber guide disposed on a surface of the substrate.

The substrate may include a rectangular plate, a disk-shaped plate, etc.

The substrate may include a thermally conductive material.

The thermally conductive material may include at least one of aluminum, copper, and the like.

The fiber guide may guide the coil into a planar spiral.

The fiber guide may include a groove defined on the surface of the substrate and the fiber guide may be dimensioned to partially enclose the fiber and to enhance a thermal contact of the fiber and the substrate.

The fiber guide groove may be etched, machined, laser cut, etc. into the substrate.

The fiber guide may include at least one end guide groove to support at least one of an input end and an output portion of the fiber, and a main guide groove connected to the at least one end guide groove and including a planar spiral groove to support a main portion of the fiber.

At least a portion of one end guide groove may be deeper than the main guide groove, such that fiber supported by the main guide groove passes above the fiber supported in the portion of the end guide groove.

The fiber coil may further include a material disposed between the fiber in the portion of the end guide groove and the main guide groove to prevent direct contact of the fiber.

The fiber coil may further include an adhesive to secure the fiber to the fiber guide groove.

The fiber coil may further include a potting material to couple the fiber to the fiber guide groove.

The fiber coil may further include a thermal grease to enhance thermal contact between the fiber and the substrate.

The thermal grease may be a high-silver-content thermal grease.

The fiber coil may further include a plurality of alignment elements disposed on the planar substrate to align the fiber coil form during a fiber coil assembly process.

The fiber coil may further include a plurality of alignment elements to facilitate automated fabrication of the laser fiber.

The fiber coil may further include a plurality of mounting elements disposed on the planar substrate to mount components of the fiber laser.

The components may include at least one of passive heat dissipaters, active heat dissipaters, optical elements, and a pump source.

The fiber coil may further include a plurality of strain relief boots disposed on the substrate to correspond to the fiber guide groove and to prevent the fiber from bending past manufacturer specifications.

The fiber coil may further include passive heat dissipaters disposed on the substrate.

The passive heat dissipaters may include at least one of fins, texturing, etc.

The fiber coil may further include a second substrate, the second substrate defining at least another end guide groove to support at least one of an input end and an output end of the fiber, wherein the at least another end guide groove is defined into a surface of the second substrate facing the surface of the substrate, and the second substrate is placed over the first substrate to form the fiber coil form.

The foregoing and/or other aspects and utilities of the present invention may also be achieved by providing a fiber laser thermal coil form, including a thermally conductive substrate to support a fiber placed thereon and to dissipate a heat of the fiber, and a fiber guide groove defined in a surface of the substrate to guide the fiber and dimensioned to partially enclose the fiber and to enhance a thermal contact of the fiber and the substrate, the fiber guide groove including a first end guide groove to support a first end of the fiber, a main guide groove connected to the first end guide groove and including a planar spiral groove to support a main portion of the fiber and to define a planar spiral coil of fiber, and a second end guide groove to support a second end of the fiber, the second end guide groove connected to the main guide, wherein at least a portion of the first end guide groove is deeper than the main guide groove such that the fiber placed within the main guide groove is above the fiber disposed in the portion of the first end guide groove.

The thermally conductive material may include at least one of aluminum, copper, and the like.

The fiber laser thermal may further include a material disposed between the fiber in the partially deeper portion of the first end guide groove and the fiber in the main guide groove to prevent direct contact of the fiber.

The fiber laser thermal may further include at least one of an adhesive to secure the fiber to the fiber guide groove, a potting material to couple the fiber to the fiber guide groove, and a thermal grease to enhance a thermal contact between the fiber and the planar substrate.

The fiber laser thermal may further include a plurality of alignment elements disposed on the substrate to align the fiber laser thermal coil form during a fiber coil assembly process.

The fiber laser thermal may further include passive heat dissipaters disposed on the substrate.

The foregoing and/or other aspects and utilities of the present invention may also be achieved by providing a fiber laser, including a fiber to act as an active gain medium, a pump source to input energy into the fiber, a fiber form to support the fiber, the fiber form including a thermally conductive substrate to dissipate a heat generated by the fiber, and a fiber guide groove defined on an outer surface of the substrate, to guide the fiber into a planar spiral coil, the fiber guide groove dimensioned to partially surround the fiber and to enhance a thermal contact of the fiber and the substrate.

The fiber guide groove may include a planar spiral guide groove to support a main portion of the fiber, and at least one end guide groove to support at least one of an input end and an output end of the fiber, the end guide groove connected to the planar spiral guide groove, wherein at least a portion of one end guide groove is deeper than the planar spiral guide groove, such that the fiber supported by the planar spiral guide groove passes above the fiber supported in the portion of the one end guide groove.

The fiber laser may further include a material to prevent direct contact of fiber disposed between the fiber supported by the planar spiral guide groove and the fiber supported in at least the portion of the one end guide groove.

The fiber laser may further include at least one of passive heat dissipaters and active heat dissipaters.

The passive heat dissipaters may be disposed on the substrate and comprise at least one of fins, texturing, and the like.

The active heat dissipaters may include at least one of fans, water coolers, peltier coolers, and the like.

The fiber laser may further include at least one of an adhesive to secure the fiber to the fiber guide and a thermal grease to enhance a thermal contact between the fiber and the substrate.

The fiber may be a double-clad fiber, a singe-clad fiber, a single-mode optical fiber, and/or a multimode optical fiber.

The fiber laser may further include a plurality of Bragg gratings spliced into the fiber to act as a least one of a reflector and an output coupler.

The foregoing and/or other aspects and utilities of the present invention may also be achieved by providing a fiber coiler to coil fiber on a coil form, the fiber coiler including a stage to support a fiber coil form, a winding head to place fiber on the coil form, a gantry to support the winding head, and a controller to control movements of the winding head and the gantry during coiling of the fiber.

The coil form may include a track feature to guide the winding head during application of the fiber.

The coil form may include a plurality of alignment markers to guide the winding head during application of the fiber.

The fiber coiler may further include an adhesive applicator to apply an adhesive to the fiber to secure the fiber to the coil form.

The fiber coiler may further include a thermal grease applicator to apply a thermal grease to the fiber to enhance a thermal contact between the fiber and the coil form.

The coil form may include a thermally conductive substrate to support the fiber and to dissipate a heat of the fiber, and a fiber guide groove defined on an outer surface of the substrate to guide the fiber into a planar spiral coil, the fiber guide groove dimensioned to partially surround the fiber and to enhance a thermal contact of the fiber and the substrate.

The fiber guide groove may include a planar spiral groove guide to support a main portion of the fiber, and at least one end guide groove to support at least one of an input end and an output end of the fiber, the end guide groove connected to the planar spiral guide groove, wherein at least a portion of one end guide groove is deeper than the planar spiral guide groove, such that the fiber supported by the planar spiral guide groove passes above the fiber supported in the portion of the one end guide groove.

The foregoing and/or other aspects and utilities of the present invention may also be achieved by providing a fiber coiling system, including a fiber coiler, and a fiber coil form, wherein the fiber coiler comprises a stage to support the fiber coil form, a winding head to place fiber on the fiber coil form, a gantry to support the winding head, and a controller to control movements of winding head and the gantry during coiling of the fiber, and wherein the fiber coil form comprises a thermally conductive substrate to support the fiber and to dissipate a heat of the fiber, and a fiber guide groove defined on an outer surface of the substrate, to guide the fiber into a planar spiral coil, the fiber guide groove dimensioned to partially surround the fiber and to enhance a thermal contact of the fiber and the substrate.

The fiber guide groove may include a planar spiral guide groove to support a main portion of the fiber, and at least one end guide groove to support at least one of an input end and an output end of the fiber, the end guide groove connected to the planar spiral guide groove, wherein at least a portion of one end guide groove is deeper than the planar spiral guide groove, such that the fiber supported by the planar spiral guide groove passes above the fiber supported in the portion of the one end guide groove.

The coil form may include a track to guide the winding head during application of the fiber.

The coil form may include a plurality of alignment markers to guide the winding head during application of the fiber.

The fiber coiling may further include an adhesive applicator to apply an adhesive to the fiber to secure the fiber to the coil form.

The fiber coiling may further include a thermal grease applicator to apply a thermal grease to the fiber to enhance a thermal contact between the fiber and the coil form.

The foregoing and/or other aspects and utilities of the present invention may also be achieved by providing a method of fabricating a fiber laser coil using a fiber coiling system, the fiber coiling system comprising, a fiber coiler having a stage to support a fiber coil form, a winding head to place fiber on the fiber coil form, a gantry to support the winding head, and a controller to control movements of the winding head and the gantry during coiling of the fiber, and wherein the fiber coil form comprises a thermally conductive substrate to support the fiber and to dissipate a heat of the fiber, and a fiber guide groove defined on an outer surface of the substrate to guide the fiber into a planar spiral coil, the fiber guide groove dimensioned to partially surround the fiber and to enhance a thermal contact of the fiber and the substrate, the method including placing the fiber coil form on the stage, placing a first end of the fiber into an input of the coil form, positioning the winding head to contact the fiber, the winding head forcing the fiber against the fiber coil form, controlling the winding head to place the fiber on the fiber coil form and directing the movements of the winding head and the gantry to place the fiber on the fiber coil form in a planar spiral pattern, and placing a second end of the fiber into an output of the coil form.

The coil form may include a plurality of alignment marks to align and overlay the stage and the fiber coil form.

The method may further include adhering the fiber onto the coil form.

Adhering the fiber may include applying an adhesive to the fiber before placing the fiber in the coil form.

Adhering the fiber may include applying an adhesive to the coil form before placing the fiber in the coil form.

The method may further include applying a thermal grease between the fiber and the coil form.

Applying the thermal grease may include applying the thermal grease to the coil form before placing the fiber in the coil form.

Applying the thermal grease may include applying the thermal grease to the fiber before placing the fiber in the coil form.

The fiber guide groove may include a planar spiral guide groove to support a main portion of the fiber in the planar spiral pattern, and at least one end guide groove to support at least one of an input and output of the fiber, the end guide groove connected to the planar spiral guide groove, wherein at least a portion of one end guide groove is deeper than the planar spiral guide groove, such that the fiber supported by the planar spiral guide groove passes above the fiber supported in the portion of the one end guide groove.

The method may further include applying a material to prevent direct contact of fiber, the material disposed between the fiber supported by the planar spiral guide groove and the fiber supported in at least the portion of the one end guide groove.

### BRIEF DESCRIPTION OF THE DRAWINGS

The accompanying drawings, which are included to provide a further understanding of the disclosed fiber laser thermal coil form and related manufacturing techniques and are incorporated in and constitute a part of this specification, illustrate various embodiments and, together with the description, serve to explain the principles of at least one embodiment of the disclosed fiber laser thermal coil form and related manufacturing techniques.

The above, and/or other aspects and advantages of the present invention will become apparent and more readily appreciated from the following description of the embodiments, taken in conjunction with the accompanying drawings of which:

FIG. 1 illustrates a conventional laser.

FIG. 2 illustrates a fiber laser usable in an embodiment of the present invention.

FIG. 3 illustrates a coiled fiber laser according to an embodiment of the present invention.

FIG. 4 illustrates a fiber laser thermal coil form according to an embodiment of the present invention.

FIG. 5 illustrates a front view of the fiber laser thermal coil form illustrated in FIG. 4.

FIG. 6 illustrates a winding head according to an embodiment of the present invention.

FIG. 7 illustrates a fiber placement apparatus according to an embodiment of the present invention.

FIG. 7A illustrates a stage according to an embodiment of the present invention.

FIG. 8 illustrates a fiber placement process according to an embodiment of the present invention.

FIG. 9 illustrates a fiber placement apparatus according to another embodiment of the present invention.

FIG. 10 illustrates a fiber placing process according to another embodiment of the present invention.

FIG. 11 illustrates a thermal coil form rendering according to an embodiment of the present invention.

FIGS. 12-14 illustrate a fiber being placed by a winding head according to an embodiment of the present invention.

FIGS. 15-16 illustrate a fiber placement apparatus according to an embodiment of the present invention.

### DETAILED DESCRIPTION OF THE PREFERRED EMBODIMENT

Reference will now be made in detail to embodiments of the present invention, examples of which are illustrated in the accompanying drawings, wherein like reference numerals refer to the like elements throughout. The embodiments are described below in order to explain the present invention by referring to the figures.

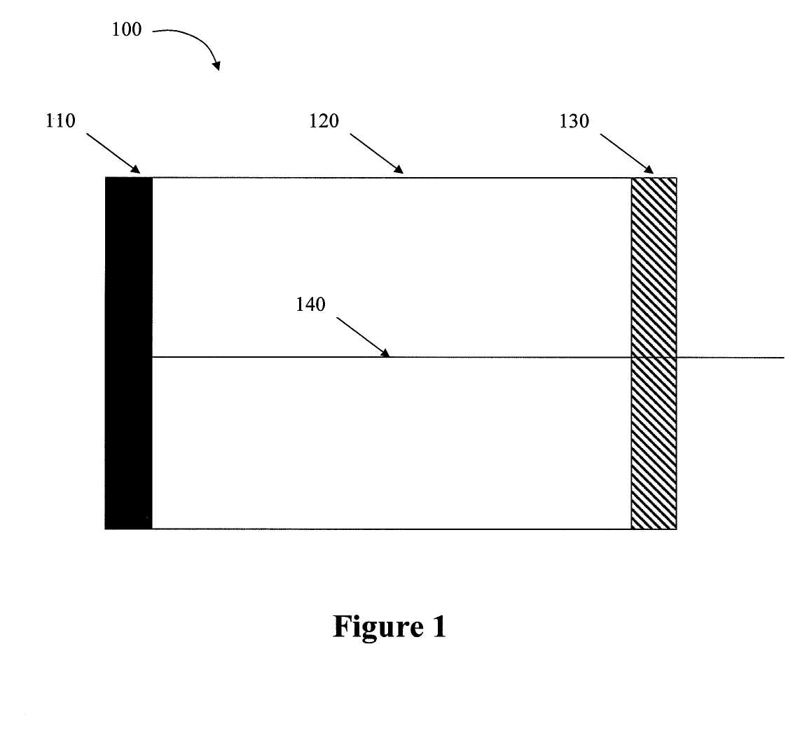

FIG. 1 illustrates a conventional laser. As illustrated in FIG. 1, a laser 100 may include a reflector 110, an active gain medium 120, and an output coupler 130. Laser 100 can be operated by inputting energy, i.e. “pumping”, into the active gain medium 120 via an external energy source, including, but not limited to, electrical current, flashlamp, light from another laser, radio-frequency (RF), or the like.

The active gain medium 120 can be made of various materials, each of which will emit radiation of a different frequency. Selection of the appropriate active gain medium depends upon the desired characteristics of the output radiation, such as frequency. One commonly used active gain medium is helium-neon gas (HeNe) which emits radiation at 633 nm (red light). Carbon Dioxide is another commonly used active gain medium used in laser cutting and welding applications. Metal ions, solid materials (such as ruby), and reactive chemicals (such as KrF in excimer lasers), may also be used as an active gain medium.

As the active gain medium 120 is pumped, particles within the active gain medium 120 are placed into a high-energy quantum state. Particles in a high-energy quantum state can interact with a laser beam 140 within the active gain medium 120 by either absorbing photons or emitting photons. Photons emitted by a particle in a high-energy quantum state will be emitted in the same direction as the laser beam 140 that interacted with the particle from which they are emitted.

As the active gain medium 120 is pumped, the number of particles in the high-energy quantum state increases until the active gain medium 120 reaches population inversion, at which point more particles within the active gain medium 120 are in a high-energy quantum state than in a lower-energy quantum state. At this point the amount of photons being emitted by the active gain medium 120 will be greater than those being absorbed, leading to amplification. The reflector 110 is typically highly reflective, whereas the output coupler 130 is typically partially reflective and partially transparent. The output coupler 130 can emit a portion of the laser beam 140 while reflecting a portion of the laser beam 140 back through the active gain medium 120 to provide further amplification. The reflector 110 and the output coupler 130 may act to further increase amplification, by causing laser beam 140 to repeatedly interact with the active gain medium 120 before being emitted through the output coupler 130. Each interaction of the laser beam 140 with the active gain medium 120 emits more photons in the same direction as laser beam 140 thereby amplifying its intensity.

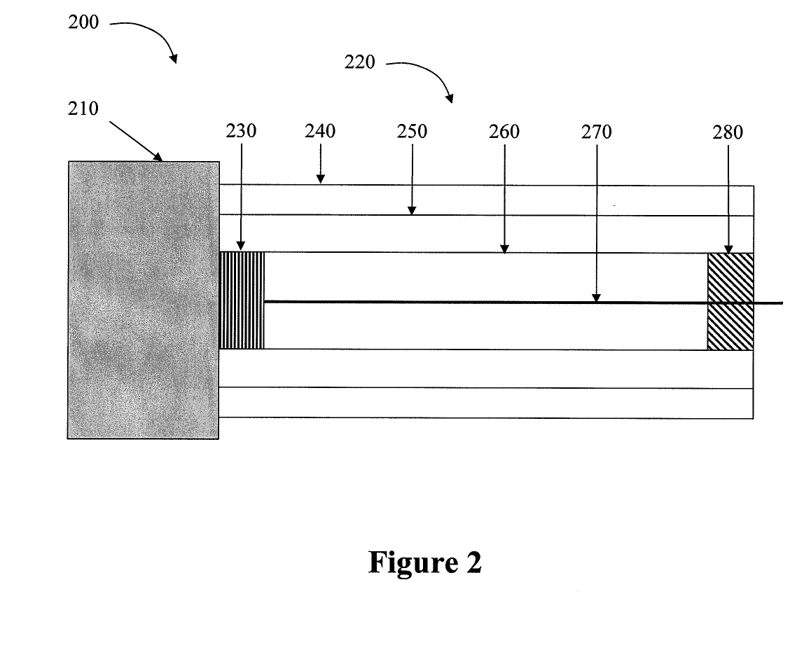

In a fiber laser, an optical fiber can be used as the active gain medium. FIG. 2 illustrates a fiber laser usable in embodiments of the present invention. As illustrated in FIG. 2, a fiber laser 200 may include a pump source 210 and a fiber 220. The pump source 210 may be provided by a semiconductor diode laser, another fiber laser, or the like. For example, suitable pump sources include, but are not limited to, the Compact Laser Diode Driver distributed by Multiwave of Portugal, the D560 distributed by Apollo Instruments of Irvine, Calif., or the like.

Various optical fiber types may be used as the fiber 220, depending on the desired characteristics for the laser produced. For example, the fiber 220 may be a double-clad fiber 220 including an outer cladding 240, an inner cladding 250, and a core 260. The core 260 may include an active gain medium. For example, the core 260 may be an optical fiber doped with one or more rare-earth elements thereby allowing it to act as an active gain medium. Suitable rare-earth elements include, but are not limited to, erbium, ytterbium, neodymium, thulium, or the like. The core 260 may include single-mode or multimode optical fibers.

The inner cladding 250 and outer cladding 240 may have a lower refractive index than the core 260. In addition, the inner cladding 250 may have a lower refractive index than outer cladding 240. The inner cladding 250 may serve to carry the output from the pump source 210, allowing the pump source 210 to effectively pump the core 260 as the active gain medium. The outer cladding 240 may serve to maintain the pump energy within the inner cladding 250. Suitable double-clad fiber includes, but is not limited to, Cladding Pumped Fiber distributed by OFS of Norcross, Ga. In some embodiments, such as industrial cutting applications, the fiber 220 may be between 10 and 15 meters in length.

The fiber 220 may also be embodied as a single-clad fiber. For example, referring to FIG. 2, a single-clad fiber 220 may lack the outer cladding 240. Single clad fibers may be used in low-power applications, whereas double-clad fibers are more desirable in high-power applications because the outer cladding 240 allows the core 260 to be pumped with a high power multimode beam.

The fiber laser 200 may further include a reflector 230 and an output coupler 280. The reflector 230 and the output coupler 280 may act to cause a portion of a laser beam 270 to repeatedly traverse the core 260, further amplifying the output of the fiber laser 200. In some embodiments, the reflector 230 and/or the output coupler 280 may be provided by one or more Bragg gratings.

A Bragg grating may be created in the fiber by introducing a periodic variation to the refractive index of the core 260 of the fiber 220 resulting in a wavelength-specific mirror. Fiber Bragg gratings can be manufactured by introducing the periodic refractive index variation into the fiber 220 via one or more ultraviolet (“UV”) sources. The variations may be patterned by interfering the beams of two or more UV sources, patterning via a photomask, or writing individual points with a UV source. In some embodiments, Fiber Bragg gratings allow the reflector 230 and the output coupler 280 to be monolithically integrated with the fiber 220 via splicing or other means.

While double-clad and single-clad optical fibers usable to fabricate fiber lasers are described above, the present invention is not limited thereto. Instead, the present invention is usable with a wide variety of fibers used in fiber laser manufacture.

In a conventional fiber laser, the fiber 220 is wound around a cylindrical mandrel, thereby providing the fiber laser 200 with a smaller footprint. However, the smaller footprint can also increase an amount of heat per area. Components of the fiber laser 200, such as the fiber Bragg gratings, may be sensitive to heat and thus may be affected by the hear produced by the fiber during operation. Additionally, heat differences along the fiber 220 may induce stress on the fiber 220, reducing the efficiency and output power of the fiber laser 200. Winding the fiber 220 around a cylindrical mandrel can also induce diffusion currents in the fiber 220, causing further stress. In some high-peak power or femto-second applications, stress-induced birefringence caused by thermal fluctuations of the gain fiber can limit the stability and/or lower the energy output of the fiber laser.

Further, as described above, conventional fiber lasers are manually assembled. Accordingly, a majority of the cost associated with low-power fiber lasers manufacture comes from human assembly and mechanical fixture costs. As noted in the January 2008 edition of Laser Focus World, “[i]t is hard to envision a future when even the most basic fiber laser would not involve a significant amount of manual handling in the assembly process.” See, Stuart Woods & Tobias Pfanz, DPSS lasers rival fiber lasers for marking applications, LASER FOCUS WORLD, January 2008, at 99.

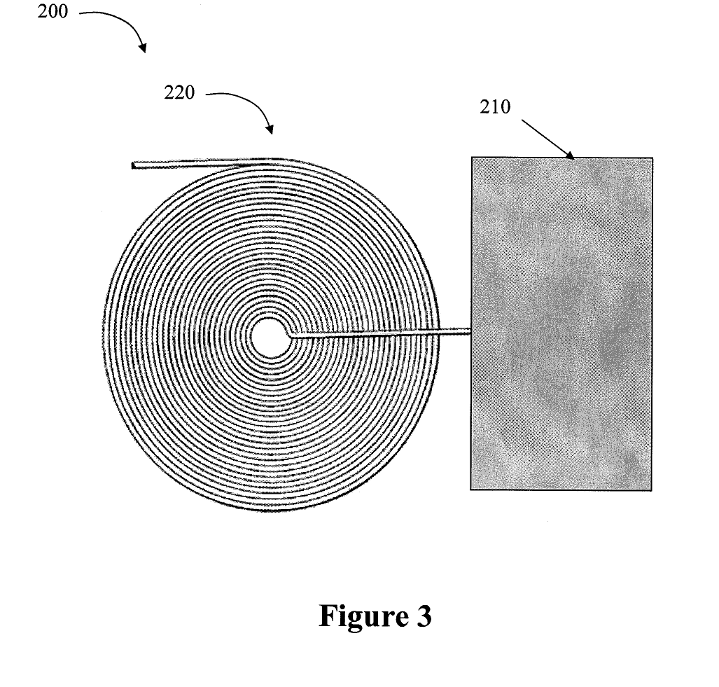

In contrast, embodiments of the present invention allows automated fiber laser fabrication. In some embodiments of the present invention, the fiber 220 may be arranged in a planar spiral as illustrated in FIG. 3. Arranging the fiber 220 in a planar spiral substantially minimizes diffusion currents and the mechanical stresses associated therewith in the coil while still providing a compact footprint. Moreover, the method of assembly is cost-efficient and less labor intensive than traditional methods and is also suitable for automation, allowing for coiling of a fiber in about 15 minutes.

The present invention provides a fiber laser coil form and related manufacturing apparatus and techniques to fabricate a fiber laser coil. The fiber laser coil provides improve thermal characteristics for the fiber laser, while allowing an automated manufacture thereof.

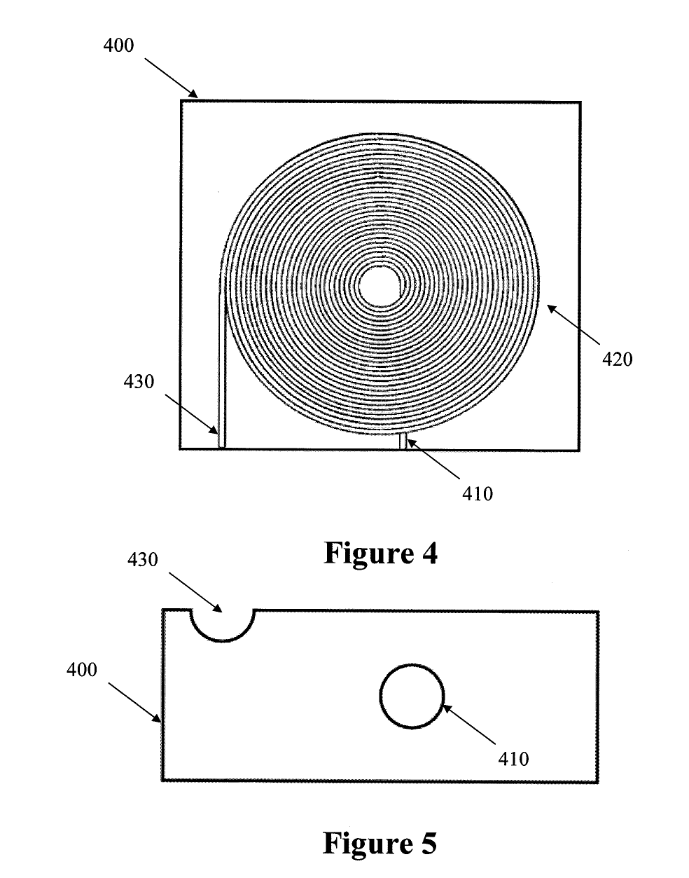

FIG. 4 illustrates a fiber laser thermal coil form according to an embodiment of the present invention. As illustrated in FIG. 4, a thermal coil form 400 may be utilized to fabricate a fiber laser. The thermal coil form 400 may be fabricated from a thermally conductive material, such as, but not limited to, aluminum, copper, or the like, to dissipate heat generated by the fiber laser during operation.

The thermal coil form 400 may include one or more of an input fiber guide 410, a spiral fiber guide 420, and an output fiber guide 430 (hereinafter collectively referred to as “fiber guides”) each of which may further include one or more alignment marks for facilitating automated fabrication of a fiber laser. The input fiber guide 410 and the output fiber guide 430 may be interchangeable and may be provided at various locations on the thermal coil form 400 to better suit the requirements of a specific application. While the thermal coil form 400 illustrated in FIG. 4 has a rectangular shape, the present invention is not limited thereto, and coil forms according to embodiments of the present invention may have other shapes. For example, the thermal coil form 400 may be circular or disk shaped. In other examples of the present invention, the spiral fiber guide 420 may zigzag but continue to be spiral, and the thermal coil form 400 could have a dome shape or other non-flat structure to allow for different packing arrangements.

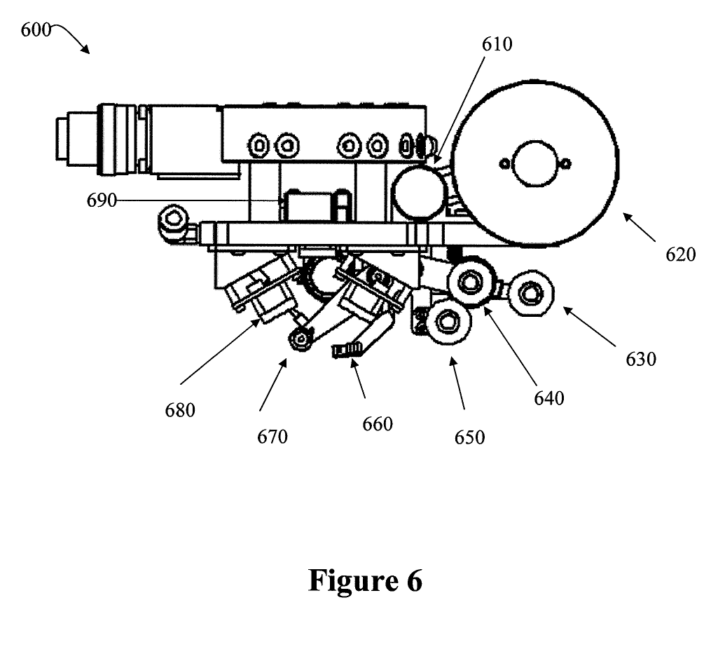

The fiber guides may be provided as indentations or grooves defined in the thermal coil form 400. The fiber guides may have a width corresponding to that of a fiber disposed therein to establish a thermal contact between the fiber and thermal coil form 400. The indentations or grooves may be provided by machining, laser cutting, or the like. The input fiber guide 410 and the output fiber guide 430 may be provided at similar depths in the thermal coil form 400. Alternatively, as illustrated in FIG. 5, the input fiber guide 410 may be disposed at a lower depth than the output fiber guide 430. Additionally, at least one of an adhesive, a thermal compound, and a potting material may be deposited in the fiber guides prior to placing the fiber in the fiber guide to secure the fiber placed thereon, enhance a thermal contact of the fiber and the thermal coil form 400, etc.

In fiber applications that require high thermal dissipation, a thermal grease may also be used to improve a thermal conductivity of the fiber with the thermal coil form 400. For example, a thermal grease with a high silver content can be used. Care must be taken in selecting a thermal grease to avoid material incompatibilities between the thermal grease and fiber. For example, some thermal greases can interact with silica based polymers and acrylates commonly found in fiber cladding, inducing swelling in the fiber. Thermal greases having solvents also have the possibility of the solvent attacking the fiber, leading to stress-corrosion-cracking events. A suitable thermal compound is Arctic Silver 5, distributed by Arctic Silver of Visalia, Calif., USA. This material can be applied to the fiber guides or be provided in a bath and die arrangement that allows the fiber to be preloaded with the compound prior to placement.

As illustrated by FIG. 5, a portion of the input fiber guide 410 may be set deeper in thermal coil form 400 than the spiral fiber guide 420 and/or the output fiber guide 430 to allow the input fiber guide 410 to pass under the fiber coiled in the spiral fiber guide 420, thereby avoiding stacking stresses and allowing the planar spiral to be wound in an automated fashion.

In some embodiments of the present invention, the thermal coil form 400 may include a first plate with the input fiber guide 410 and the spiral fiber guide 420 defined thereon, while the output fiber guide 430 may be provided in a second plate which is placed on top of the first plate through which the fiber is threaded.

The thermal coil form 400 may further include mounting hardware for additional optical elements, the pump source 210, or the like. The input fiber guide 410 and/or the output fiber guide 430 may further include strain relief boots. Strain relief boots can further ruggedize the thermal coil form 400 and prevent fiber damage by ensuring that the fiber exiting the input fiber guide 410 and/or the output fiber guide 430 is not bent further than the manufacturer minimum bend radius specification. In some embodiments, the thermal coil form 400 may further include passive heat dissipation features, such as, but not limited to, fins, texturing, or the like, or active heat dissipation devices, such as, but not limited to, fans, water cooling, peltier coolers, or the like.

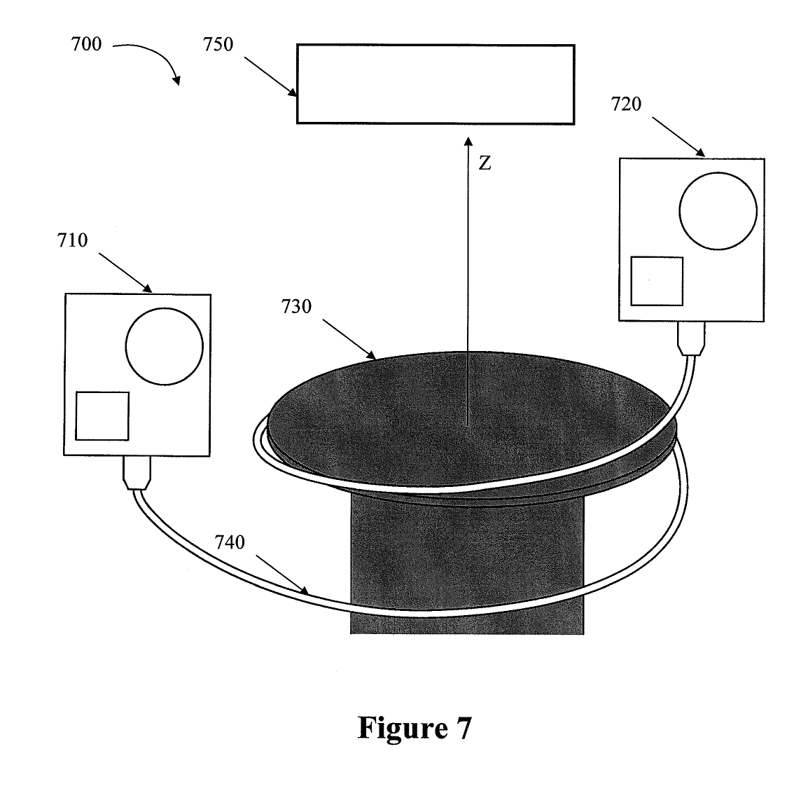

FIG. 6 illustrates a winding head according to an embodiment of the present invention. A winding head may be utilized to place a fiber onto a substrate, such as thermal coil form 400 in an automated fashion. As illustrated in FIG. 6, the winding head 600 may include a feed motor 610, a fiber spool 620, a fiber tensioner 630, a fiber length encoder 640, an idler pulley 650, a fiber guide 660, a fiber applicator 670, a camera 680 and a height sensor 690. Fiber spool 620 is driven by feed motor 610. Fiber is fed from the fiber spool 620 over the fiber tensioner 630, then between the fiber length encoder 640 and the idler pulley 650. An example of a suitable motor for controlling the fiber tensioner 630 includes, but is not limited to, the 2224012SR DC Micromotor distributed by MicroMo Electronics, Inc., of Clearwater, Fla., USA. Bulk fiber may be pre-spooled on the fiber spool 620, or only a necessary amount of fiber to perform a job may be spooled on the fiber spool 620 prior to executing the job.

The fiber tensioner 630 may provide a nominal tension, e.g., usually less than 35 grams, to the fiber optic cable as it is fed from the fiber spool 620 to control unwanted spool “unwinding” that can cause feed issues or fiber breakage. In some embodiments, the fiber tensioner 630 may act in a closed loop with the feed motor 610. For example, as the tension on the fiber tensioner 630 increases, the rotational speed of the feed motor 610 increases. Conversely, when the tension on the fiber tensioner 630 decreases, the rotational speed of the feed motor 610 decreases.

The fiber length encoder 640 provides a measurement of the length of fiber that has been fed from the fiber spool 620. A suitable optical encoder includes, but is not limited to, the E4P-250-250-H Miniature Optical Kit Encoder distributed by US Digital of Vancouver, Wash., or the like. The fiber length encoder 640 can be spring loaded against the idler pulley 650 such that the idler pulley 650 guides fiber being fed to the fiber guide 660. The fiber guide 660 orients the fiber such that it may be applied to the substrate. The fiber guide 660 may include a first half and a second half such that the fiber may be threaded through the fiber guide 660 without requiring the fiber to have a cut end.

In some embodiments, the fiber applicator 670 may include a solenoid or pneumatic cylinder operated arm with a ball bearing mounted wheel used to apply pressure to the fiber as it comes into contact with the substrate. The wheel maintains the fiber in position by applying force to the fiber, to facilitate effective contact between the fiber and the substrate to which it is being applied. In some embodiments, the wheel may be mounted to a lever arm, thereby allowing the height of winding head 600 to vary while maintaining pressure on the fiber. As described above, an adhesive, a thermal compound, and/or a potting material may be used while placing the fiber to increase a thermal contact of the fiber and the substrate.

Camera 680 may include at least one camera to observe the fiber as it is applied. Camera 680 may be used by a human operator or by vision hardware/software to automate production. In some embodiments, the camera 680 may be used to align winding head 600 with the substrate by utilizing one or more alignment marks provided on the substrate. For example, by using the fiber guides provided on the thermal coil form 400. Alternatively, physical guides may be used to guide the winding head 600. In such embodiments, the winding head 600 can be configured without a camera 680.

In some embodiments, the height sensor 690 provides a winding head height relative to the substrate. The winding head height may be used to apply the fiber to a substrate with varying heights. Suitable sensors for the height sensor 690 include, but are not limited to, sensors from the U-Gage Q45UR Remote Ultrasonic Series distributed by Banner Engineering Corp. of Minneapolis, Minn.

As described above, the winding head 600 is capable of precisely placing fiber on various substrates of varying size and topology. The winding head 600 may also be adapted to less demanding substrates, such as planar surfaces, by removing certain components. High-volume applications may also allow the removal of one or more of the previously described components. By way of example, without limitation, the thermal coil form 400 may include a track feature capable of guiding the winding head 600, thereby allowing the winding head 600 to precisely place the fiber without the use of camera 680. Individual components of winding head 600 may be removed for application specific needs without departing from the spirit or scope of the invention.

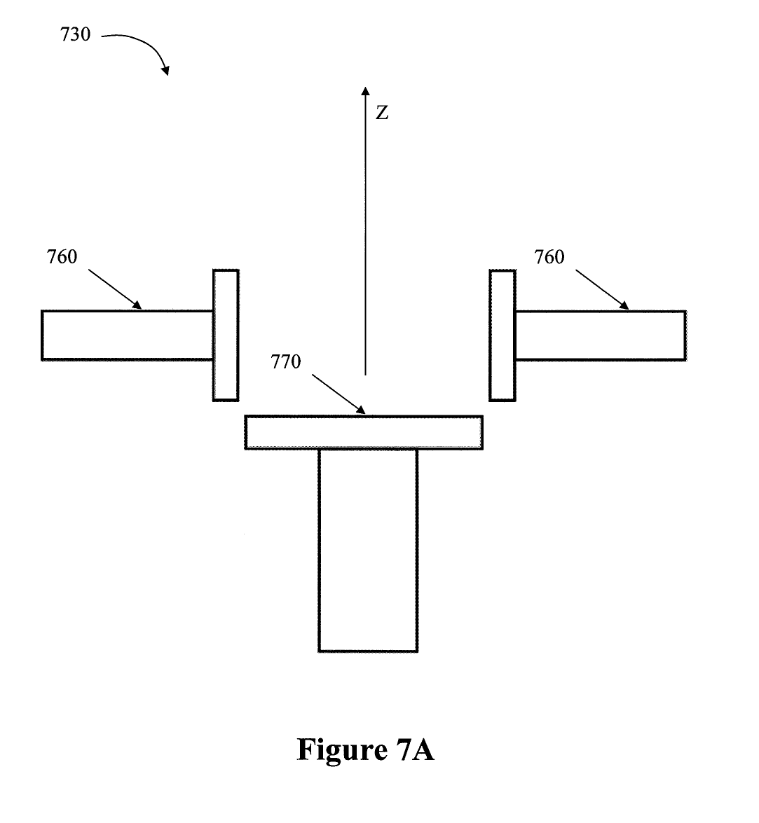

FIG. 7 illustrates a fiber placement apparatus according to an embodiment of the present invention. As illustrated in FIG. 7, a fiber placement apparatus 700 may include a first winding head 710, a second winding head 720, a stage 730, and a controller 750, the controller 750 being communicatively coupled to the first winding head 710, the second winding head 720, and the stage 730. The first and second winding heads 710 and 720 may each be similar to the winding head 600 illustrated in FIG. 6. The controller 750 may include a general purpose computer, the general purpose computer capable of receiving a design layout (such as an output file from a Computer Aided Design software package) denoting where fiber is to be placed, converting the design layout to one or more mechanical movements, and directing the first winding head 710, the second winding head 720, and the stage 730 to perform those mechanical movements. The controller 750 may be connected to one or more networks to facilitate the transfer of a design layout from a workstation to the controller 750. In some embodiments, the controller 750 may allow manual operation of the fiber placement apparatus 700.

The controller 750 may further include one or more microcontrollers for interfacing between the controller 750 and control circuitry of the first winding head 710, the second winding head 720, and the stage 730. In some embodiments, the controller 750 may be communicatively coupled to the first winding head 710, the second winding head 720, and the stage 730 via one or more electrical wires, one or more fiber optic cables, one or more wireless links, or the like.

The various components of the fiber placement apparatus 700 may be capable of movement in several directions, making the fiber placement apparatus 700 capable of precisely placing fiber 740 on a substrate having varied topology. In some embodiments, the first winding head 710 and the second winding head 720 are capable of movement in the x-axis, the y-axis, the z-axis, and the θ-axis. This multi-axis motion may be provided by mounting the first winding head 710 and the second winding head 720 to one or more gantries, one or more articulated arms, or the like.

In some embodiments, the stage 730 may be capable of movement in the z-axis (as illustrated in FIG. 7), the θ₁-axis, and the θ₂-axis. Movement in the θ₁-axis is defined as rotation in the x-y plane. Movement in the θ₂-axis is defined as rotation in one or more of the z-x plane and the z-y plane, such that the stage 730 can be aligned at an angle other than normal to the z-axis. In some embodiments, as illustrated by FIG. 7, the stage 730 may provide a planar surface for mounting a substrate thereto.

As illustrated in FIG. 7A, the stage 730 may also include one or more lateral substrate holders 760 and a planar substrate support 770. The one or more lateral substrate holders 760 can engage the substrate by applying lateral pressure, one or more clamps, vacuum, electrostatic force, adhesive, or the like. Substrate holders 760 allow the substrate to be rotated along the θ₂-axis, thereby allowing fiber placement apparatus 700 to place fiber along multiple surfaces of the substrate without requiring a human operator. The planar substrate support 770 can be lowered along the z-axis to allow rotation of the substrate along the θ₂-axis, then raised underneath the substrate to provide support during while fiber is being applied to the substrate.

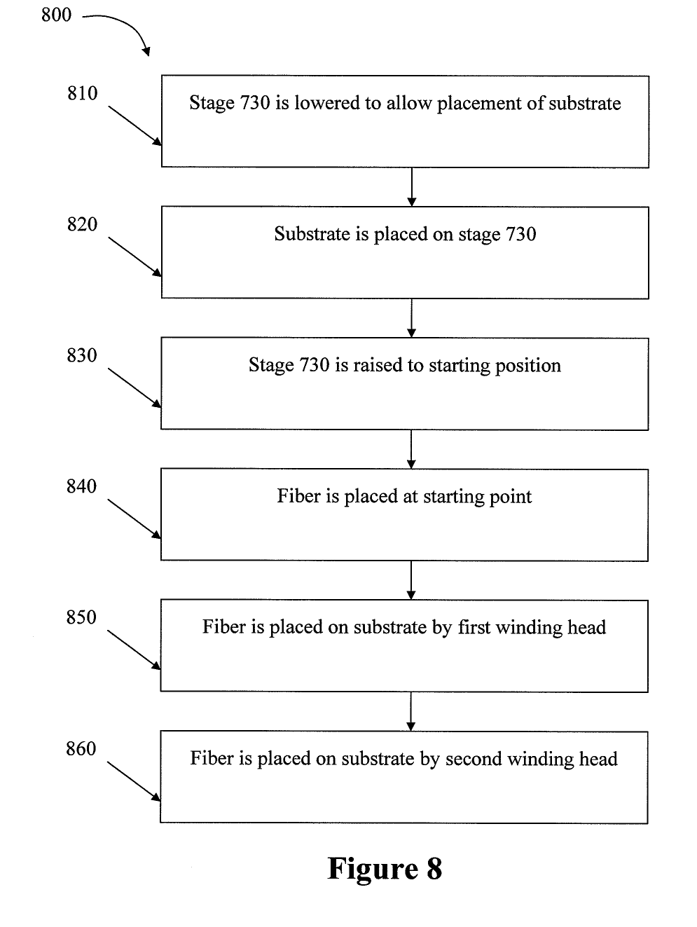

FIG. 8 illustrates a fiber placement process according to an embodiment of the present invention. The fiber may be placed according to this process on a substrate, such as the thermal coil form 400 utilizing the fiber placement apparatus 700 illustrated in FIGS. 7-7A. As illustrated in FIG. 8, in operation 810, the stage 730 is lowered along the z-axis to provide sufficient clearance between the stage 730 and the first and second winding heads 710 and 720 to allow placement of a substrate on the stage 730. The substrate can be a thermal coil form 400 as illustrated in FIGS. 4-5. Sufficient clearance between the stage 730, and the first winding head 710 and the second winding head 720 may also be provided by raising the first winding head 710 and second winding head 720 along their z-axis.

In operation 820, the substrate is placed on the stage 730, either via an automated placement mechanism or by a human operator. In some embodiments, operation 820 may further include one or more alignment and overlay operations so that the fiber placement apparatus 700 can determine the location of the substrate on the stage 730. In operation 830, the stage 730 is raised into a starting position.

In operation 840, the fiber 740 is placed at a starting point on the substrate. In some embodiments, the fiber placement apparatus 700 may place fiber 740 at the starting point on the substrate, whereas in other embodiments, the initial placement may require a human operator to attach the fiber 740 to the substrate. An adhesive material may be used for the initial placement of the fiber 740. By way of example, without limitation, when the substrate comprises a thermal coil form, such as thermal coil form 400 illustrated in FIGS. 4-5, the winding apparatus 700 may require manual placement of the fiber 740 within the input fiber guide 410.

In operation 850, the controller 750 directs the first winding head 710 to place a portion of the fiber 740 on the substrate by converting the design layout to one or more mechanical movements, and directing the first winding head 710 to perform those mechanical movements. By way of example, without limitation, to apply fiber in a clock-wise spiral pattern, starting at the 12 o'clock position, the controller 750 would instruct the first winding head 710 to dispense fiber while moving in the positive x-direction, the negative y-direction, and rotating in the θ-axis. A more complicated set of mechanical movements may be required when applying fiber in a complex pattern on a substrate having varying topology.

Similarly, in operation 860, the controller 750 directs the second winding head 720 to place a portion of the fiber 740 on the substrate. A design layout may require one or more repetitions of operation 850 and operation 860, each of which may entail different mechanical movements.

In some embodiments, where it may be desired to place fiber into a groove or trough in a substrate that runs at an angle other than normal to the surface of the substrate, the stage 730 may be rotated in the θ₂-axis.

It should be noted that the fiber placement apparatus 700 as described above is capable of placing fiber in complex patterns on one or more surfaces of a substrate having a varying topology. Although the general applicability of fiber placement apparatus 700 as described is highly advantageous, the cost and complexity of implementing the fiber placement apparatus 700 may be reduced by removing one or more components of fiber placement apparatus 700 for application specific uses. For example, as described below, the present invention can also be embodied as a single winding head fiber placement apparatus to place fiber in a planar spiral, such as defined in the thermal coil form 400.

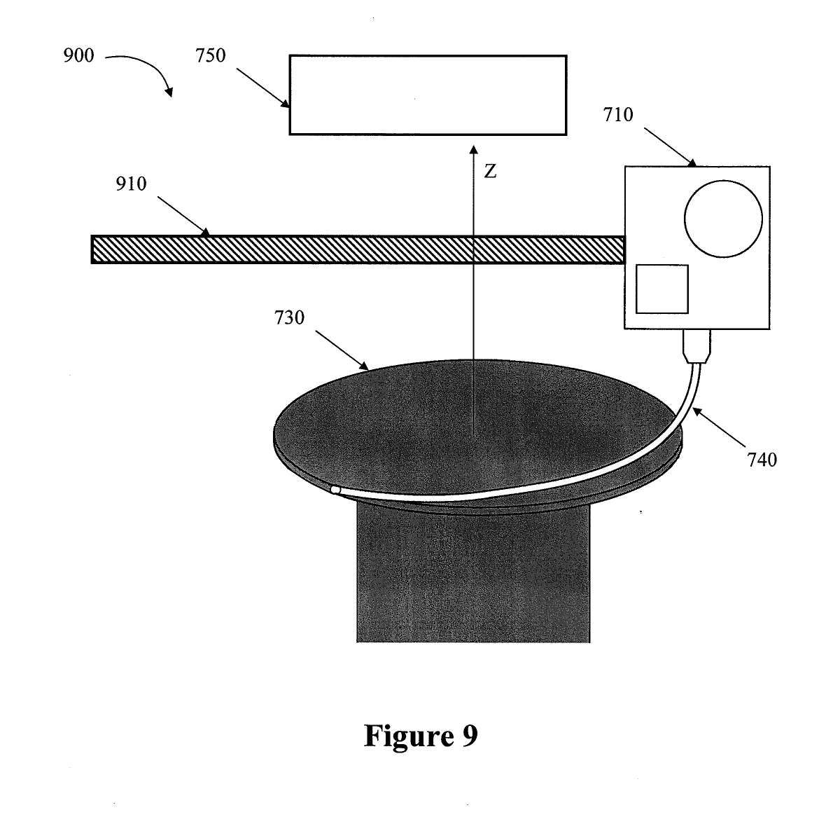

FIG. 9 illustrates a fiber placement apparatus according to another embodiment of the present invention. As illustrated in FIG. 9, a fiber placement apparatus 900 may be adapted for placing fiber 740 in a pattern on a substrate, such as thermal coil form 400. The fiber placement apparatus 900 may include a first winding head 710, a stage 730, a controller 750, and a gantry 910. The first winding head 710 may be similar to the winding head 600 illustrated in FIG. 6. The first winding head 710 may be operatively coupled to the gantry 910, thereby allowing the first winding head 710 to move in the x-axis, the y-axis, the z-axis, and the θ-axis. As described above, the stage 730 may be capable of movement in various axis to allow mounting of the substrate thereon or to facilitate placement of the fiber on the substrate. Alternatively, in some embodiments, the stage 730 may be fixed.

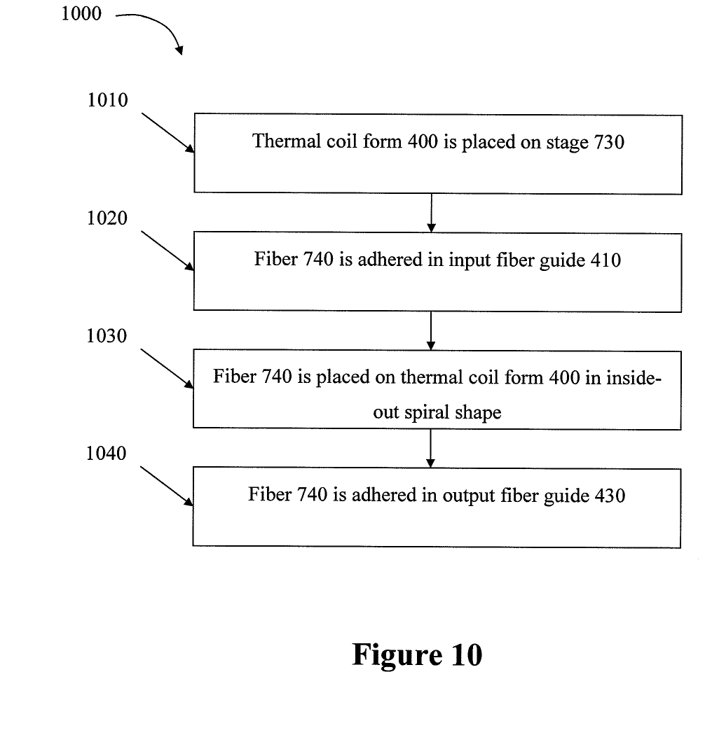

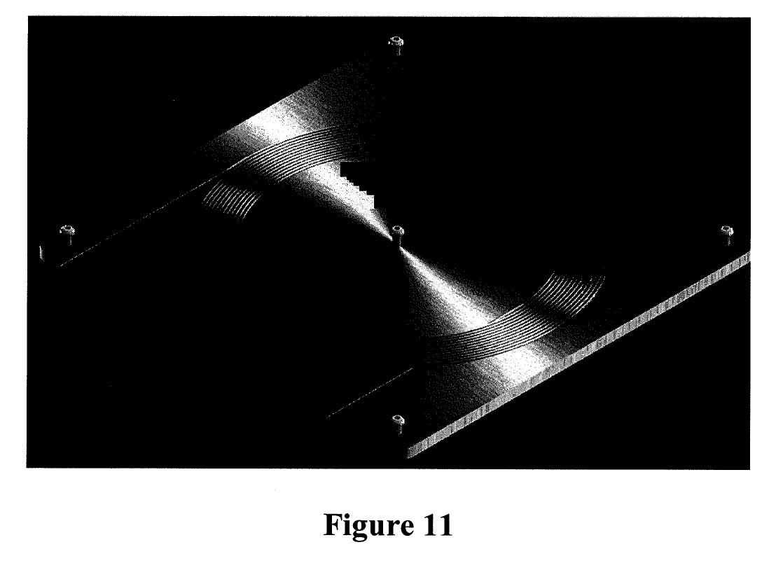

FIG. 10 illustrates a fiber placing process according to another embodiment of the present invention. The fiber may be placed according to this process on a substrate, such as thermal coil form 400 utilizing the fiber placement apparatus 900 illustrated in FIG. 9. As illustrated in FIG. 10, in operation 1010, a substrate, such as a thermal coil form 400, is placed on the stage 730. the substrate and/or the stage 730 may further include alignment marks for providing alignment and overlay between the stage 730 and the thermal coil form 400.

In operation 1020, a first end of the fiber 740 is placed in the input fiber guide 410. The fiber 740 may be adhered in place. The input fiber guide 410 may have one or more of an adhesive, a potting material, and a thermal interface material applied to it prior to having the first end of the fiber 740 placed therein to secure the fiber to the substrate, to increase a thermal contact of the fiber to the substrate, etc. The adhesive or potting material may also be applied after the fiber is placed in the fiber guides. Alternatively, the thermal interface material may also be provided in a bath and die arrangement that allows the fiber to be preloaded with the thermal interface prior to placement. A bath and die arrangement may also be used for the adhesive or potting material.

The input fiber guide 410 may be a trench defined into the thermal coil form 400. In such embodiments, one or more materials may be used to fill the trench after the first end of fiber 740 is placed within the input fiber guide 410, to allow subsequent sections of the fiber 740 to be placed above the fiber 740 placed within the trench without imparting stress on the fiber 740. In some embodiments the one or more materials to fill the trench may include double-sided tape. Suitable double-sided tape includes, but is not limited to, 300 Series High Strength Double Coated Tape product number 444 distributed by 3M of St. Paul, Minn., USA. The double-sided tape may cover a portion of an upper surface of the thermal coil form 400 where the fiber 740 is placed, or may cover an entire upper surface of the thermal coil form 400.

In operation 1030, the fiber placement apparatus 900 positions the first winding head 710 such that the fiber applicator 670 contacts the top of the fiber 740, thereby forcing the bottom of the fiber 740 against the thermal coil form 400. The controller 750 then directs the first winding head 710 to place the fiber 740 on the substrate while directing mechanical movements to the first winding head 710, the mechanical movements directing the first winding head 710 to move in the x-direction and y-direction, while rotating in the θ-axis, thereby placing the fiber 740 on thermal coil form 400 in an inside-out spiral pattern. In some embodiments, the fiber 740 is kept in contact with the thermal coil form 400 after it has been placed by an adhesive. Suitable adhesives include, but are not limited to, double-sided tape. While the embodiment describe above uses a double-sided tape adhesive, the present invention is not limited thereto. Instead, the present invention can use other adhesives to secure the fiber, such as spray contact adhesives or pressure sensitive adhesive tapes, etc. In some embodiments the adhesive is applied to the thermal coil form 400 prior to placement of the fiber 740. In some embodiments the first winding head 710 may further an adhesive applicator to apply adhesive to fiber 740 prior to placing the fiber 740 in contact with the thermal coil form 400.

In operation 1040, fiber 740 is adhered in the output fiber guide 430. The fiber placement apparatus 900 may place the fiber 740 in output fiber guide 430. Alternatively, an operator may manually place the fiber 740 in output fiber guide 430. In some embodiments, the output fiber guide 430 may be a trench defined in an upper surface of the thermal coil 400, as illustrated in FIGS. 4-5. In such embodiments, one or more materials may be used to fill the trench after the first end of fiber 740 is placed within the output fiber guide 430. In some embodiments the one or more materials to fill the trench may include double-sided tape. The other side of the double sided tape may be exposed to the air or to a protective plates, or may serve as an adhesive base for other fiber laser components, assemblies, or electronics.

The first winding head 710 can be operatively coupled to the gantry 910 to allow the first winding head 710 to move in the x-axis and the z-axis. In such embodiments, the stage 730 may be capable of movement in the θ₁-axis, thereby allowing the fiber placement apparatus 900 to place the fiber 740 on thermal coil form 400 in an inside-out spiral pattern.

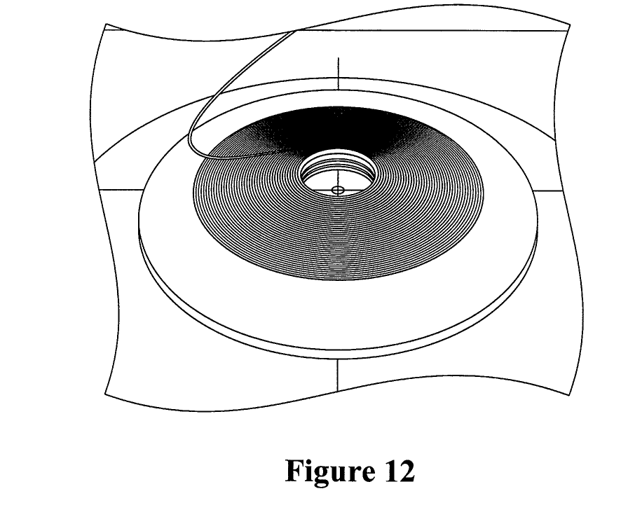

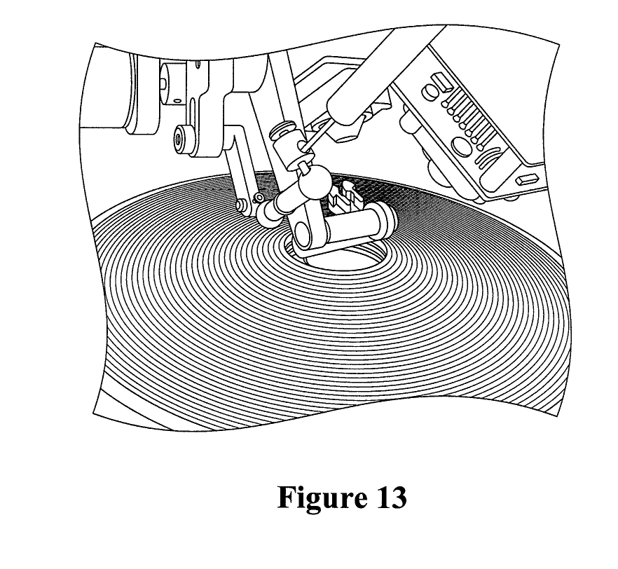

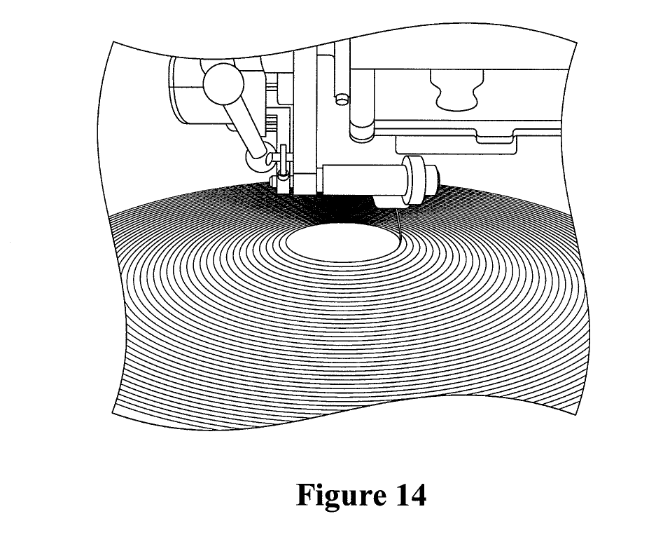

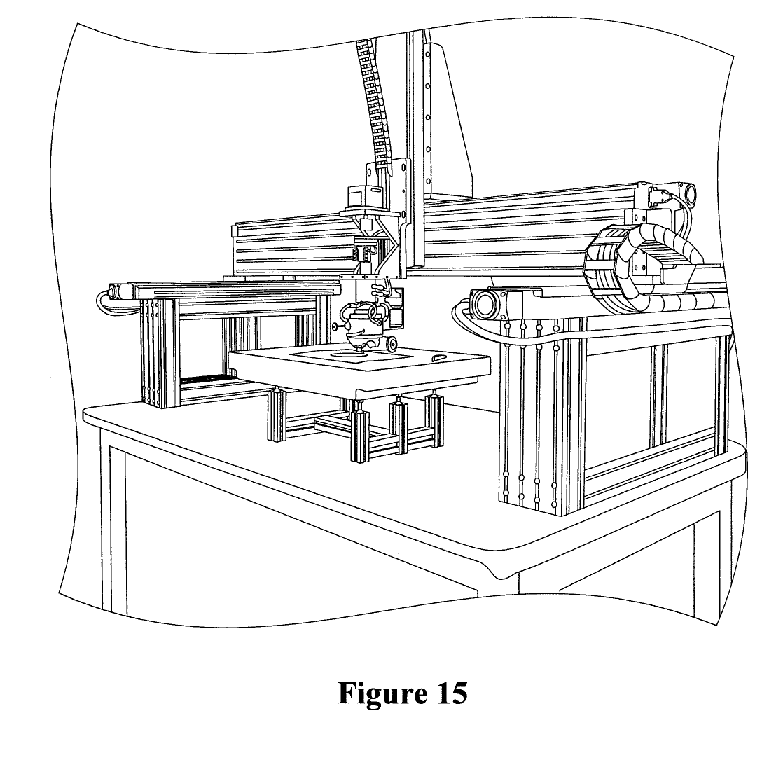

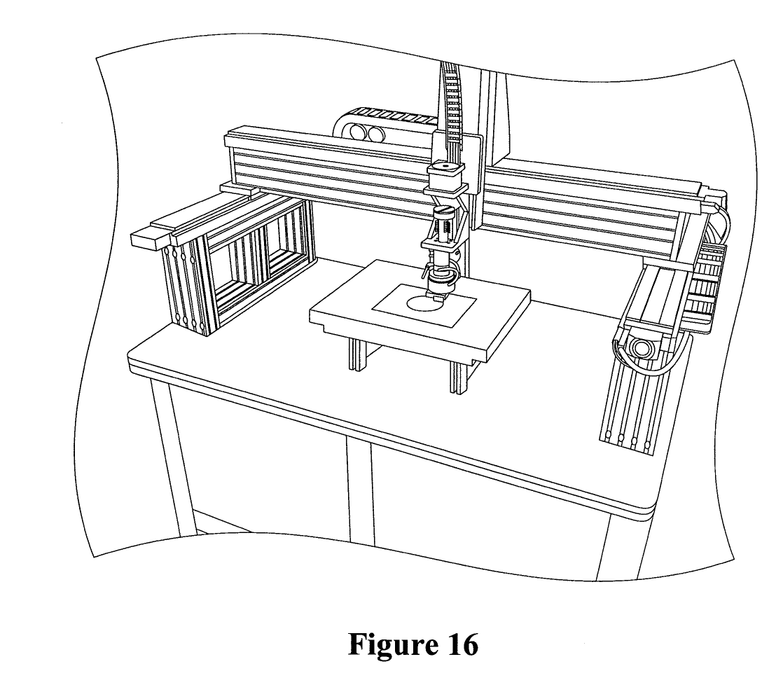

FIGS. 12-14 illustrate a fiber being placed by a winding head according to an embodiment of the invention. FIGS. 15-16 illustrate a fiber placement apparatus according to an embodiment of the invention.

Although a few embodiments of the present general inventive concept have been shown and described, it will be apparent by those skilled in the art that various changes and modifications may be made in these embodiments without departing from the principles and spirit of the present invention, the scope of which is defined in the appended claims and their equivalents.

What is claims is:

1. A fiber coil form, comprising:
a substrate to support a fiber placed thereon, and
a fiber guide to guide the fiber into a coil, the fiber guide disposed on a surface of the substrate.

2. The fiber coil form of claim 1, wherein the substrate comprises a rectangular plate.

3. The fiber coil form of claim 1, wherein the substrate comprises a disk-shaped plate.

4. The fiber coil form of claim 1, wherein the substrate comprises a thermally conductive material.

5. The fiber coil form of claim 4, wherein the thermally conductive material comprises at least one of aluminum, copper, and the like.

6. The fiber coil form of claim 4, wherein the fiber guide guides the coil into a planar spiral.

7. The fiber coil form of claim 6, wherein the fiber guide comprises a groove defined on the surface of the substrate and the fiber guide is dimensioned to partially enclose the fiber and to enhance a thermal contact of the fiber and the substrate.

8. The fiber coil form of claim 7, wherein the fiber guide groove is one of etched, machined, and laser cut into the substrate.

9. The fiber coil form of claim 7, wherein the fiber guide comprises
at least one end guide groove to support at least one of an input end and an output portion of the fiber, and
a main guide groove connected to the at least one end guide groove and comprising a planar spiral groove to support a main portion of the fiber.

10. The fiber coil form of claim 9, wherein at least a portion of one end guide groove is deeper than the main guide groove, such that fiber supported by the main guide groove passes above the fiber supported in the portion of the end guide groove.

11. The fiber coil form of claim 10, further comprising a material disposed between the fiber in the portion of the end guide groove and the main guide groove to prevent direct contact of the fiber.

12. The fiber coil form of claim 11, further comprising an adhesive to secure the fiber to the fiber guide groove.

13. The fiber coil form of claim 11, further comprising a potting material to couple the fiber to the fiber guide groove.

14. The fiber coil form of claim 10, further comprising a thermal grease to enhance thermal contact between the fiber and the substrate.

15. The fiber coil form of claim 14, wherein the thermal grease is a high-silver-content thermal grease.

16. The fiber coil form of claim 10, further comprising a plurality of alignment elements disposed on the planar substrate to align the fiber coil form during a fiber coil assembly process.

17. The fiber coil form of claim 10, wherein the fiber guide further comprises a plurality of alignment elements to facilitate automated fabrication of the laser fiber.

18. The fiber coil form of claim 10, further comprising a plurality of mounting elements disposed on the planar substrate to mount components of the fiber laser.

19. The fiber coil form of claim 18, wherein the components comprise at least one of passive heat dissipaters, active heat dissipaters, optical elements, and a pump source.

20. The fiber coil form of claim 10, further comprising a plurality of strain relief boots disposed on the substrate to correspond to the fiber guide groove and to prevent the fiber from bending past manufacturer specifications.

21. The fiber coil form of claim 10, further comprising passive heat dissipaters disposed on the substrate.

22. The fiber coil form of claim 21, wherein the passive heat dissipaters comprise at least one of fins, texturing, and the like.

23. The fiber coil form of claim 7, further comprising:
a second substrate, the second substrate defining at least another end guide groove to support at least one of an input end and an output end of the fiber,
wherein the at least another end guide groove is defined into a surface of the second substrate facing the surface of the substrate, and the second substrate is placed over the first substrate to form the fiber coil form.

24. A fiber laser thermal coil form, comprising:
a thermally conductive substrate to support a fiber placed thereon and to dissipate a heat of the fiber; and
a fiber guide groove defined in a surface of the substrate to guide the fiber and dimensioned to partially enclose the fiber and to enhance a thermal contact of the fiber and the substrate, the fiber guide groove comprising:
a first end guide groove to support a first end of the fiber,
a main guide groove connected to the first end guide groove and comprising a planar spiral groove to support a main portion of the fiber and to define a planar spiral coil of fiber, and
a second end guide groove to support a second end of the fiber, the second end guide groove connected to the main guide,
wherein at least a portion of the first end guide groove is deeper than the main guide groove such that the fiber placed within the main guide groove is above the fiber disposed in the portion of the first end guide groove.

25. The fiber laser thermal coil form of claim 24, wherein the thermally conductive material comprises at least one of aluminum, copper, and the like.

26. The fiber laser thermal coil form of claim 24, further comprising a material disposed between the fiber in the partially deeper portion of the first end guide groove and the fiber in the main guide groove to prevent direct contact of the fiber.

27. The fiber laser thermal coil form of claim 24, further comprising at least one of an adhesive to secure the fiber to the fiber guide groove, a potting material to couple the fiber to the fiber guide groove, and a thermal grease to enhance a thermal contact between the fiber and the planar substrate.

28. The fiber laser thermal coil form of claim 24, further comprising a plurality of alignment elements disposed on the substrate to align the fiber laser thermal coil form during a fiber coil assembly process.

29. The fiber laser thermal coil form of claim 24, further comprising passive heat dissipaters disposed on the substrate.

30. A fiber laser, comprising:
a fiber to act as an active gain medium;
a pump source to input energy into the fiber;
a fiber form to support the fiber, the fiber form comprising:
a thermally conductive substrate to dissipate a heat generated by the fiber, and
a fiber guide groove defined on an outer surface of the substrate, to guide the fiber into a planar spiral coil, the fiber guide groove dimensioned to partially surround the fiber and to enhance a thermal contact of the fiber and the substrate.

31. The fiber laser of claim 30, wherein the fiber guide groove comprises:
a planar spiral guide groove to support a main portion of the fiber; and
at least one end guide groove to support at least one of an input end and an output end of the fiber, the end guide groove connected to the planar spiral guide groove,
wherein at least a portion of one end guide groove is deeper than the planar spiral guide groove, such that the fiber supported by the planar spiral guide groove passes above the fiber supported in the portion of the one end guide groove.

32. The fiber laser of claim 30, further comprising:
a material to prevent direct contact of fiber disposed between the fiber supported by the planar spiral guide groove and the fiber supported in at least the portion of the one end guide groove.

33. The fiber laser of claim 31, further comprising at least one of passive heat dissipaters and active heat dissipaters.

34. The fiber laser of claim 33, wherein the passive heat dissipaters are disposed on the substrate and comprise at least one of fins, texturing, and the like.

35. The fiber laser of claim 33, wherein the active heat dissipaters comprise at least one of fans, water coolers, peltier coolers, and the like.

36. The fiber laser of claim 31, further comprising at least one of an adhesive to secure the fiber to the fiber guide and a thermal grease to enhance a thermal contact between the fiber and the substrate.

37. The fiber laser of claim 31, wherein the fiber is a double-clad fiber.

38. The fiber laser of claim 31, wherein the fiber is a singe-clad fiber.

39. The fiber laser of claim 31, wherein the fiber is a single-mode optical fiber.

40. The fiber laser of claim 31, wherein the fiber is a multimode optical fiber.

41. The fiber laser of claim 31, further comprising a plurality of Bragg gratings spliced into the fiber to act as a least one of a reflector and an output coupler.

42. A fiber coiler to coil fiber on a coil form, the fiber coiler comprising:
a stage to support a fiber coil form;
a winding head to place fiber on the coil form;
a gantry to support the winding head; and
a controller to control movements of the winding head and the gantry during coiling of the fiber.

43. The fiber coiler of claim 42, wherein the coil form comprises a track feature to guide the winding head during application of the fiber.

44. The fiber coiler of claim 42, wherein the coil form comprises a plurality of alignment markers to guide the winding head during application of the fiber.

45. The fiber coiler of claim 42, further comprising an adhesive applicator to apply an adhesive to the fiber to secure the fiber to the coil form.

46. The fiber coiler of claim 42, further comprising a thermal grease applicator to apply a thermal grease to the fiber to enhance a thermal contact between the fiber and the coil form.

47. The fiber coiler of claim 42, wherein the coil form comprises:
a thermally conductive substrate to support the fiber and to dissipate a heat of the fiber, and
a fiber guide groove defined on an outer surface of the substrate to guide the fiber into a planar spiral coil, the fiber guide groove dimensioned to partially surround the fiber and to enhance a thermal contact of the fiber and the substrate.

48. The fiber coiler of claim 47, wherein the fiber guide groove comprises:
a planar spiral groove guide to support a main portion of the fiber; and
at least one end guide groove to support at least one of an input end and an output end of the fiber, the end guide groove connected to the planar spiral guide groove,
wherein at least a portion of one end guide groove is deeper than the planar spiral guide groove, such that the fiber supported by the planar spiral guide groove passes above the fiber supported in the portion of the one end guide groove.

49. A fiber coiling system, comprising:
a fiber coiler; and
a fiber coil form,
wherein the fiber coiler comprises a stage to support the fiber coil form, a winding head to place fiber on the fiber coil form, a gantry to support the winding head, and a controller to control movements of winding head and the gantry during coiling of the fiber, and
wherein the fiber coil form comprises a thermally conductive substrate to support the fiber and to dissipate a heat of the fiber, and a fiber guide groove defined on an outer surface of the substrate, to guide the fiber into a planar spiral coil, the fiber guide groove dimensioned to partially surround the fiber and to enhance a thermal contact of the fiber and the substrate.

50. The fiber coiling system of claim 49, wherein the fiber guide groove comprises:
a planar spiral guide groove to support a main portion of the fiber; and
at least one end guide groove to support at least one of an input end and an output end of the fiber, the end guide groove connected to the planar spiral guide groove,
wherein at least a portion of one end guide groove is deeper than the planar spiral guide groove, such that the fiber supported by the planar spiral guide groove passes above the fiber supported in the portion of the one end guide groove.

51. The fiber coiling system of claim 50, wherein the coil form comprises a track to guide the winding head during application of the fiber.

52. The fiber coiling system of claim 50, wherein the coil form comprises a plurality of alignment markers to guide the winding head during application of the fiber.

52. The fiber coiling system of claim 50, further comprising an adhesive applicator to apply an adhesive to the fiber to secure the fiber to the coil form.

54. The fiber coiling system of claim 50, further comprising a thermal grease applicator to apply a thermal grease to the fiber to enhance a thermal contact between the fiber and the coil form.

55. A method of fabricating a fiber laser coil using a fiber coiling system, the fiber coiling system comprising, a fiber coiler having a stage to support a fiber coil form, a winding head to place fiber on the fiber coil form, a gantry to support the winding head, and a controller to control movements of the winding head and the gantry during coiling of the fiber, and wherein the fiber coil form comprises a thermally conductive substrate to support the fiber and to dissipate a heat of the fiber, and a fiber guide groove defined on an outer surface of the substrate to guide the fiber into a planar spiral coil, the fiber guide groove dimensioned to partially surround the fiber and to enhance a thermal contact of the fiber and the substrate, the method comprising:
placing the fiber coil form on the stage;
placing a first end of the fiber into an input of the coil form;
positioning the winding head to contact the fiber, the winding head forcing the fiber against the fiber coil form;
controlling the winding head to place the fiber on the fiber coil form and directing the movements of the winding head and the gantry to place the fiber on the fiber coil form in a planar spiral pattern; and
placing a second end of the fiber into an output of the coil form.

56. The method of claim 55, wherein the coil form comprises a plurality of alignment marks to align and overlay the stage and the fiber coil form.

57. The method of claim 55, further comprising:
adhering the fiber onto the coil form.

58. The method of claim 57, wherein adhering the fiber comprises applying an adhesive to the fiber before placing the fiber in the coil form.

59. The method of claim 57, wherein adhering the fiber comprises applying an adhesive to the coil form before placing the fiber in the coil form.

60. The method of claim 55, further comprising:
applying a thermal grease between the fiber and the coil form.

61. The method of claim 60, wherein applying the thermal grease comprises applying the thermal grease to the coil form before placing the fiber in the coil form.

62. The method of claim 60, wherein applying the thermal grease comprises applying the thermal grease to the fiber before placing the fiber in the coil form.

63. The method of claim 55, wherein the fiber guide groove comprises:
a planar spiral guide groove to support a main portion of the fiber in the planar spiral pattern; and
at least one end guide groove to support at least one of an input and output of the fiber, the end guide groove connected to the planar spiral guide groove,
wherein at least a portion of one end guide groove is deeper than the planar spiral guide groove, such that the fiber supported by the planar spiral guide groove passes above the fiber supported in the portion of the one end guide groove.

64. The method of claim 63, further comprising
applying a material to prevent direct contact of fiber, the material disposed between the fiber supported by the planar spiral guide groove and the fiber supported in at least the portion of the one end guide groove.
